(19) United States
(12) Patent Application Publication
(10) Pub. No.: US 2024/0078196 A1
(43) Pub. Date: Mar. 7, 2024

(54) CXL PERSISTENT MEMORY MODULE LINK TOPOLOGY

(71) Applicant: Dell Products L.P., Round Rock, TX (US)

(72) Inventors: Misa Wang, Shanghai (CN); Quy Ngoc Hoang, Round Rock, TX (US); Krishna Kakarla, Round Rock, TX (US)

(21) Appl. No.: 17/900,931

(22) Filed: Sep. 1, 2022

(51) Int. Cl. G06F 13/16; G06F 13/40; G06F 13/42

(52) U.S. Cl. CPC G06F 13/1668; G06F 13/409; G06F 13/4221

(57) ABSTRACT

An information handling system includes a motherboard installed within a chassis, a first backplane coupled to the motherboard, a second backplane coupled to the motherboard. The first backplane is located in a front side of the chassis, and is configured to receive first add-in modules from the front of the chassis. The second backplane is located in a middle portion of the chassis, and is configured to receive second add-in modules. The second add-in modules are positioned above DIMMs installed in the motherboard.

### FIELD OF THE DISCLOSURE

This disclosure generally relates to information handling systems, and more particularly relates to providing a persistent memory (PMEM) link topology in a compute express link (CXL) information handling system.

### BACKGROUND

As the value and use of information continues to increase, individuals and businesses seek additional ways to process and store information. One option is an information handling system. An information handling system generally processes, compiles, stores, and/or communicates information or data for business, personal, or other purposes. Because technology and information handling needs and requirements may vary between different applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, reservations, enterprise data storage, or global communications. In addition, information handling systems may include a variety of hardware and software resources that may be configured to process, store, and communicate information and may include one or more computer systems, data storage systems, and networking systems.

### SUMMARY

An information handling system may include a chassis, a motherboard installed within the chassis, a first backplane coupled to the motherboard, a second backplane coupled to the motherboard. The first backplane may be located in a front side of the chassis, and may be configured to receive first add-in modules from the front of the chassis. The second backplane may be located in a middle portion of the chassis, and may be configured to receive second add-in modules. The second add-in modules may be positioned above dual in-line memory modules (DIMMs) installed in the motherboard.

### BRIEF DESCRIPTION OF THE DRAWINGS

It will be appreciated that for simplicity and clarity of illustration, elements illustrated in the Figures have not necessarily been drawn to scale. For example, the dimensions of some of the elements are exaggerated relative to other elements. Embodiments incorporating teachings of the present disclosure are shown and described with respect to the drawings presented herein, in which:

FIG. 1 is a block diagram of a compute express link (CXL) information handling system according to an embodiment of the current disclosure;

FIG. 2 is a block diagram of a compute express link (CXL) information handling system according to another embodiment of the current disclosure;

FIG. 3 is a block diagram of a compute express link (CXL) information handling system according to another embodiment of the current disclosure; and

FIG. 4 is a block diagram illustrating a generalized information handling system according to another embodiment of the present disclosure.

The use of the same reference symbols in different drawings indicates similar or identical items.

### DETAILED DESCRIPTION OF DRAWINGS

The following description in combination with the Figures is provided to assist in understanding the teachings disclosed herein. The following discussion will focus on specific implementations and embodiments of the teachings. This focus is provided to assist in describing the teachings, and should not be interpreted as a limitation on the scope or applicability of the teachings. However, other teachings can certainly be used in this application. The teachings can also be used in other applications, and with several different types of architectures, such as distributed computing architectures, client/server architectures, or middleware server architectures and associated resources.

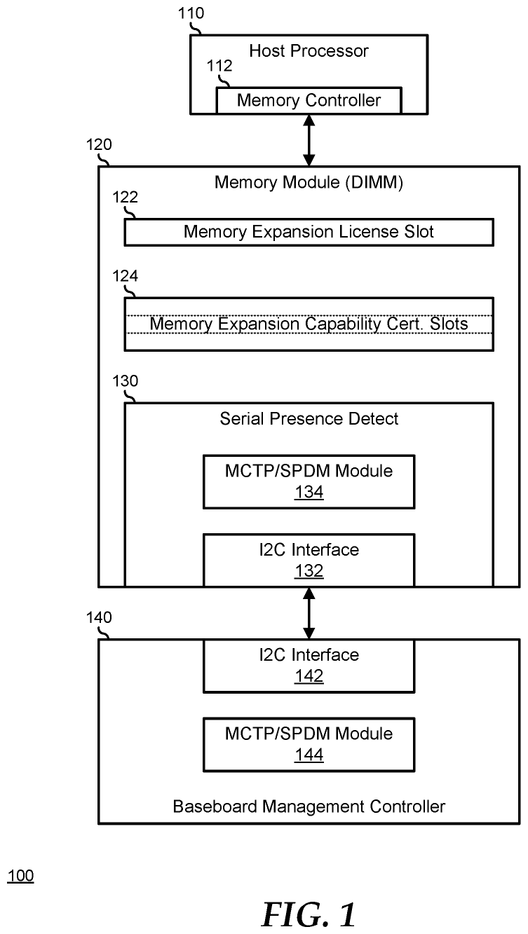

FIG. 1 shows an information handling system 100, including a host processor 110 with associated host memory 116, and an accelerator device 120 with associated expansion memory 126. Host processor 110 includes one or more processor core 111, various internal input/output (I/O) devices 112, coherence and memory logic 113, compute express link (CXL) logic 114, and a PCIe physical layer (PHY) interface 115. Coherence and memory logic 113 provides cache coherent access to host memory 116. The operation of a host processor, and particularly of the component functional blocks within a host processor, are known in the art, and will not be further described herein, except as needed to illustrate the current embodiments.

Accelerator device 120 includes accelerator logic 121, and a PCIe PHY interface 125 that is connected to PCIe PHY interface 115. Accelerator logic 121 provides access to expansion memory 126. Accelerator device 120 represents a hardware device configured to enhance the overall performance of information handling system 100. An examples of accelerator device 120 may include a smart network interface card (MC) or host bus adapter (HBA), a graphics processing unit (GPU), field programmable gate array (FPGA), or application specific integrated circuit (ASIC) device, a memory management and expansion device or the like, or another type of device configured to improve the performance of information handling system 100, as needed or desired. In particular, being coupled to host processor 110 via the PCIe link established between PCIe interfaces 115 and 125, accelerator device 120 may represent a task-based device that receives setup instructions from the host processor, and then independently executes the tasks specified by the setup instructions. In such cases, accelerator device 120 may access host memory 116 via a direct memory access (DMA) device or DMA function instantiated on the host processor. When representing a memory management device, accelerator device 120 may represent a device configured to provide an expanded memory capacity, in the form of expansion memory 126, thereby increasing the overall storage capacity of information handling system 100, or may represent a memory capacity configured to increase the memory bandwidth of the information handling system, as needed or desired.

Information handling system 100 represents an information handling system configured in conformance with a CXL standard, such as a CXL 1.1 specification, a CXL 2.0 specification, or any other CXL standard as may be published from time to time by the CXL Consortium. The CXL standard is an industry-supported interconnection standard that provides a cache-coherent interconnection between processors, accelerator devices, memory expansion devices, or other devices, as needed or desired. In this way, operations performed at diverse locations and by diverse architectures may maintain a memory coherency domain across the entire platform. The CXL standard provides for three (3) related protocols: CXL.io, CXL.cache, and CXL.memory. The CXL.io protocol represents an I/O protocol that is based upon the PCIe 5.0 protocol (for CXL specification 1.1) or the PCIe 6.0 protocol (for CXL specification 2.0).

For example, the CXL.io protocol provides for device discovery, configuration, and initialization, interrupt and DMA handling, and I/O virtualization functions, as needed or desired. The CXL.cache protocol provides for processors to maintain a cache-coherency domain with accelerator devices and their attached expansion memory, and with capacity- and bandwidth-based memory expansion devices, as needed or desired. The CXL.memory protocol permits processors and the like to access memory expansion devices in a cache-coherency domain utilizing load/store-based commands, as needed or desired. Further, the CXL.memory protocol permits the use of a wider array of memory types than may be supported by processor 110. For example, a processor may not provide native support for various types of non-volatile memory devices, such as Intel Optane Persistent Memory, but the targeted installation of an accelerator device that supports Intel Optane Persistent Memory may permit the information handling system to utilize such memory devices, as needed or desired.

In this regard, host processor 110 and accelerator device 120 each include logic and firmware configured to instantiate the CXL.io, CXL.cache, and CXL.memory protocols. In particular, within host processor 110, coherence and memory logic 113 instantiates the functions and features of the CXL.cache and CXL.memory protocols, and CXL logic 114 implements the functions and features of the CXL.io protocol. Further, PCIe PHY 115 instantiates a virtual CXL logical PHY. Likewise, within accelerator device 120, accelerator logic 121 instantiates the CXL.io, CXL.cache, and CXL.memory protocols, and PCIe PHY 125 instantiates a virtual CXL logical PHY. Within a CXL enabled accelerator device such as accelerator device 120, both the CXL.cache and CXL.memory protocols do not have to be instantiated, as needed or desired, but any CXL enabled accelerator device must instantiate the CXL.io protocol.

In a particular embodiment, the CXL standard provides for the initialization of information handling system 100 with a heavy reliance on existing PCIe device and link initialization processes. In particular, when information handling system 100 is powered on, the PCIe device enumeration process operates to identify accelerator 120 as a CXL device, and that the operations of the accelerator, in addition to providing for standard PCIe operation, functions, and features, may be understood to provide for additional CXL operation, functions, and features. For example, accelerator 120 enables CXL features such as global memory flush, CXL reliability, availability, and serviceability (RAS) features, CXL metadata support, and the like. In addition to the enablement of the various CXL operation, functions, and features, accelerator 120 will be understood to enable operations at higher interface signaling rates, such as 16 giga-transfers per second (GT/s) or 32 GT/s.

Persistent memory (PMEM) is a solid-state high-performance byte-addressable memory device that resides on a memory bus of an information handling system. However, unlike traditional dynamic random access memory (DRAM) memory devices, PMEM is non-volatile, retaining the stored data when power is removed from the PMEM. Being on the memory bus allows PMEM to have DRAM-like access times to the stored data, with nearly the same speed and latency of DRAM memory devices, and the nonvolatility of NAND flash. Non-volatile dual in-line memory modules (NVDIMMs) and Intel 3D)(Point DIMMs, also known as Optane DC persistent memory modules (DCPMMs) are two examples of persistent memory technologies. Support for various types and form factors of PMEMs is currently limited, but is continuously increasing. For example, some types of PMEM devices are provided in DIMM form factor, but support for PMEM DIMMs on a memory interface of a processor is not currently universally supported, or may be limited as to the number of PMEM DIMMs that may be installed into an information handling system.

For example, on particular information handling systems with Intel processors, if PMEM DIMMs are included in the DIMM sockets, then the number of DRAM DIMM modules that can be supported is reduced to eight (8) per processor. In another example, on particular information handling systems with AMD processors, PMEM modules are available in front-of-chassis storage slots. However, such front-of-chassis storage slots experience high signal integrity degradation due to the distance between the processor and the front-of-chassis riser card, and higher cost due to the introduction of Peripheral Component Interconnect—Express (PCIe) cables between a mainboard of the information handling system and the riser card. Further, such AMD-based information handling systems may typically utilize CPU south-side PCIe ports, increasing routing complexity and reducing the overall storage capacity of the information handling system.

The advent of the CXL protocol and the rise of enterprise and data small form factor (EDSFF) specifications for device form factors has provided a path to converge PMEM devices for a highly adaptable family of devices for use in enterprise servers. In particular, the EDSFF specifications offer particular advantages over incumbent device form factors, including: capacity, scalability, performance, serviceability, manageability, thermal and power management, and the like. One particular feature is the convergence on the PCIe interface as the standard interface for EDSFF devices. The convergence to the PCIe interface coincides with the use of the PCIe interface as the foundational interface of the CXL protocol where, in addition to these form factor advantages, the implementation of the CXL protocol provides for a system wide system physical address (SPA) space, memory coherency, and data movement advantages, as described above. Thus, CXL EDSFF PMEM devices have a great advantage in the path to wide spread adoption within the server space.

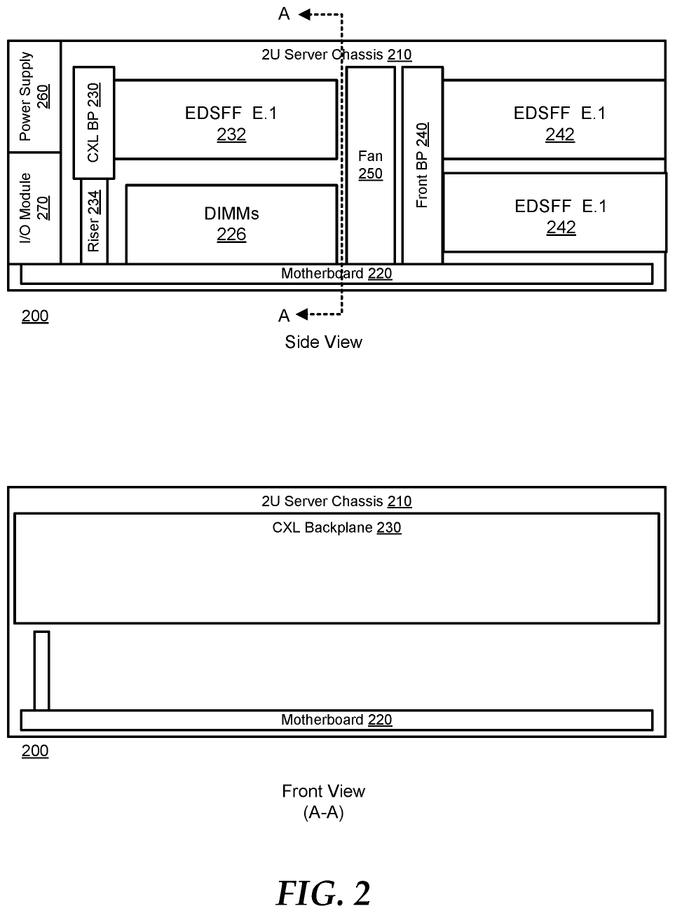

FIG. 2 illustrates an information handling system 200. In particular, information handling system 200 is provided within a 2U server chassis 210, and includes a motherboard 220, a mid-chassis CXL backplane 230, a front-of-chassis backplane 240, cooling fans 250, power supplies 260, and input/output (I/O) modules 270. Motherboard 220 is populated with a pair of processors 222 that are each cooled by heat sinks 224, and with DIMMs 226 that provide a portion of the system main memory. Mid-chassis backplane 230 is populated with Enterprises and Data Small Form Factor (EDSFF) devices 232 configured in accordance with an E.1 form factor. Front-of-chassis backplane 240 is populated with EDSFF devices 242 configured in accordance with the E.1 form factor.

In so far as information handling system 200 is similar to typical 2U servers, motherboard 220 will be understood to represent a server mainboard configured to provide interconnections between the components of the information handling system. Here, two (2) processors 222 are illustrated, but it will be understood that other numbers of processors, e.g., four (4) processors, may be provided as needed or desired. Processors 222 are typically installed into sockets and are provided with heat sinks 224 that extend upward into an airflow provided by fans 250 to maintain the operating temperatures of the processors within acceptable levels. Within 2U servers, such heat sinks 224 typically extend upwards to close to the top of 2U server chassis 210 to subject the heat sinks to the maximum amount of cooling air flow as possible. DIMMs 226 are arranged in rows extending outward from processors 222, where the DIMMs are connected to memory interfaces to the associated processors. Here, it will be understood that DIMMs 226 are typically shorter than the stack-up of processors 222 and their associated heat sinks 224, and provide a profile that extends upward from motherboard 220 to substantially half the height of 2U server chassis 210.

Further to information handling system 200 being similar to typical 2U servers, front-of-chassis backplane 240 is arranged to a front side of fans 250, and provide socketed mounting apparatus for the installation of EDSFF devices 242. Here, typically, EDSFF devices 242 may be arranged in two (2) rows of 32 EDSFF devices. EDSFF devices 242 represent a mass storage capacity for information handling system 200, and may represent flash Solid State Drives (SSDs), PMEMs, or other types of memory devices, as needed or desired. Fans 250 are typically located across the entire face of information handling system 200 to provide a uniform, high-volume airflow to cool the components of the information handling system. Power supplies 260 receive input power from one or more external power rails and converts the input power to the various voltage rails needed by information handling system 200. I/O modules 270 provide for connectivity between information handling system 200 and other processing elements of a datacenter and other network elements, as needed or desired. The details of 2U server design, cooling, and operation, are known in the art and will not be further described herein, except as may be needed to illustrate the current embodiments.

Mid-chassis CXL backplane 230 is located southward within 2U server chassis 210 from the arrangement of processors 222 and DIMMs 224. Here, the term “southward” may be understood to be a convention for describing the location of elements of a server with respect to the airflow provided by fans 250, where the north side is understood to represent the cold isle at the front of a row of server racks from which the chilled air is provided, and where the south side is understood to represent the hot isle at the back of the row of server racks from which the hot air is withdrawn. In this configuration, mid-chassis CXL backplane 230 takes advantage of the typically unused space above DIMMs 226 within 2U server chassis 210 for the inclusion of additional EDSFF devices 232. Here 24 EDSFF devices 232 are illustrated as being in a single row except for the location where heat sinks 224 extend. Here further, mid-chassis CXL backplane 230 is illustrated as being connected to motherboard 220 by one or more riser connections 234. In this way, the storage capacity of information handling system 200 is increased. Advantageously, the arrangement of riser connections 234 on the south side of processors 222 permit for shorter signaling distances between the processors and mid-chassis CXL backplane 230, than between the processor and front-of-chassis backplane 240. In particular, the signal integrity issues cited above with respect to PMEM devices is mitigated by the proximity of riser connectors 234 to processors 222. Thus, mid-chassis CXL backplane 230 provides an opportune location for the installation of PMEM devices, leaving the DIMM slots available for population with DRAM DIMMs and the front-of-chassis backplane available for population with flash SSD EDSFF devices, as needed or desired.

Note that mid-chassis CXL backplane 230 is illustrated as being populated with 24 EDSFF devices. Here, it will be understood that this may represent a greater number of EDSFF devices than my reasonably be included within a 2U server chassis in the space above the DIMMs, and that factors of signal density between processors 222, riser connectors 234, and mid-frame CXL backplane 230 may practically limit the number of EDSFF devices 232 that may be installed into the mid-frame CXL backplane. Here, mid-frame CXL backplane 230 may include one or more PCIe bridge device or CXL switch device to fan out the connections from riser connector 234 to the installed EDSFF devices 232, as needed or desired.

Note further that other types of devices may utilize the EDSFF sockets provided on mid-chassis CXL backplane 230, as needed or desired. For example, other types of devices, such as add-in cards or accelerator cards may be provided in and EDSFF-type package in the future, and such devices would be available for installation into a CXL mid-chassis backplane, as needed or desired. Moreover, while mid-chassis CXL backplane 230 is shown and described as being a CXL-based backplane, it will be understood that other architectures may be utilized in a mid-chassis backplane, as needed or desired. In this regard, other types of devices may be socketed into such a mid-chassis backplane, such as may be provided by other types of riser connectors like SATA cables, network standard cables, or the like.

Further, note that the provision of mid-chassis CXL backplane 230 southward from processors 222 and DIMMs 226, as illustrated, is not the only location that a mid-chassis backplane can be located. For example, a mid-chassis backplane may be located between fans 250 and the stack-up of processors 222 and DIMMs 226, as needed or desired. Here, any installed EDSFF devices will be understood to similarly inhabit the area above DIMMs 226. However, such a topology would likely utilize northward PCIe interfaces of processors 222, and would not necessarily benefit from the availability of the southward PCIe interfaces.

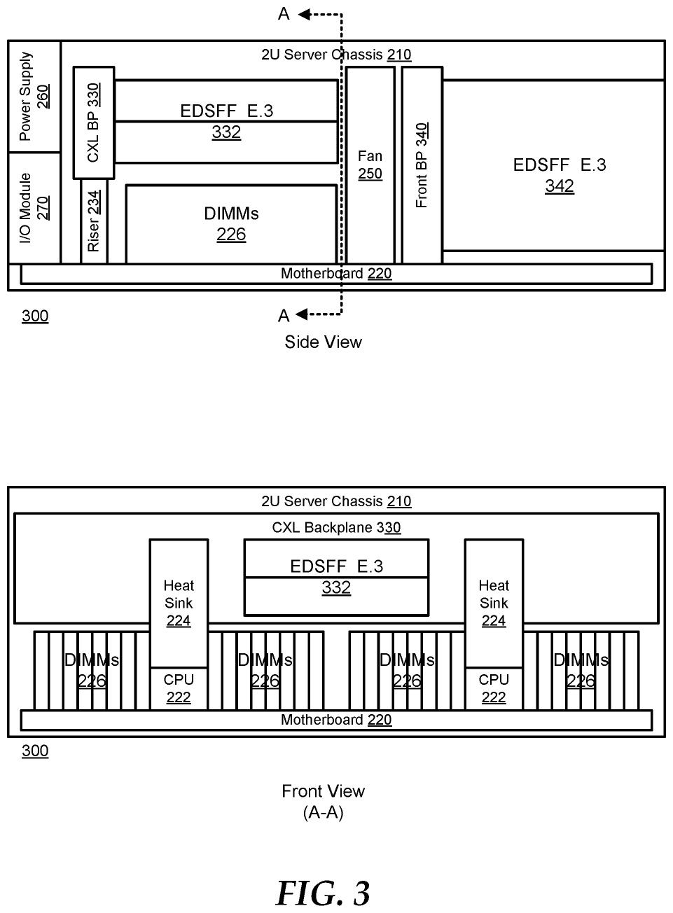

FIG. 3 illustrates an information handling system 300, similar to, and including common elements with information handling system 200. In particular, information handling system 200 is provided within a 2U server chassis 210, and includes a motherboard 220, a mid-chassis CXL backplane 330, a front-of-chassis backplane 340, cooling fans 250, power supplies 260, and input/output (I/O) modules 270. Motherboard 320 is populated with a pair of processors 222 that are each cooled by heat sinks 224, and with DIMMs 226 that provide a portion of the system main memory. Mid-chassis backplane 330 is populated with Enterprises and Data Small Form Factor (EDSFF) devices 332 configured in accordance with an E.3 form factor. Front-of-chassis backplane 340 is populated with EDSFF devices 342 configured in accordance with the E.3 form factor.

In so far as information handling system 300 is similar to information handling system 200, both information handling systems may share a common motherboard 220, populated with processors 222, heat sinks 224, and DIMMs 226, fans 250, power supplies 260, and I/O modules 270. However, here, information handling system 300 is populated with mid-chassis CXL backplane 330, connected to motherboard 220 via connector riser 234, and with front-of-chassis backplane 340. Both of backplanes 330 and 340 are configured to accommodate the installation of EDSFF devices 332 and 342. Here, information handling system 300 shares the advantages of information handling system 200, as described above, while accommodating another rising device form factor in the EDSFF E.3 form factor. In other aspects, information handling system 200 and information handling system 300 may be understood to be identical to each other, sharing common firmware, hardware, operating systems (OS), and the like.

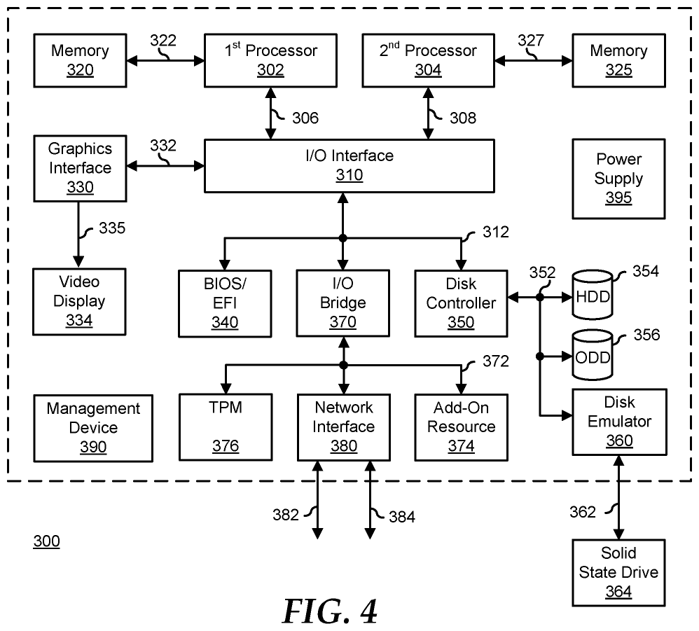

FIG. 4 illustrates a generalized embodiment of an information handling system 400. For purpose of this disclosure an information handling system can include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, information handling system 400 can be a personal computer, a laptop computer, a smart phone, a tablet device or other consumer electronic device, a network server, a network storage device, a switch router or other network communication device, or any other suitable device and may vary in size, shape, performance, functionality, and price. Further, information handling system 400 can include processing resources for executing machine-executable code, such as a central processing unit (CPU), a programmable logic array (PLA), an embedded device such as a System-on-a-Chip (SoC), or other control logic hardware. Information handling system 400 can also include one or more computer-readable medium for storing machine-executable code, such as software or data. Additional components of information handling system 400 can include one or more storage devices that can store machine-executable code, one or more communications ports for communicating with external devices, and various input and output (I/O) devices, such as a keyboard, a mouse, and a video display. Information handling system 400 can also include one or more buses operable to transmit information between the various hardware components.

Information handling system 400 can include devices or modules that embody one or more of the devices or modules described below, and operates to perform one or more of the methods described below. Information handling system 400 includes processors 402 and 404, an input/output (I/O) interface 410, memories 420 and 425, a graphics interface 430, a basic input and output system/universal extensible firmware interface (BIOS/UEFI) module 440, a disk controller 450, a hard disk drive (HDD) 454, an optical disk drive (ODD) 456, a disk emulator 460 connected to an external solid state drive (SSD) 462, an I/O bridge 470, one or more add-on resources 474, a trusted platform module (TPM) 476, a network interface 480, a management device 490, and a power supply 495. Processors 402 and 404, I/O interface 410, memory 420 and 425, graphics interface 430, BIOS/UEFI module 440, disk controller 450, HDD 454, ODD 456, disk emulator 460, SSD 462, I/O bridge 470, add-on resources 474, TPM 476, and network interface 480 operate together to provide a host environment of information handling system 400 that operates to provide the data processing functionality of the information handling system. The host environment operates to execute machine-executable code, including platform BIOS/UEFI code, device firmware, operating system code, applications, programs, and the like, to perform the data processing tasks associated with information handling system 400.

In the host environment, processor 402 is connected to I/O interface 410 via processor interface 406, and processor 404 is connected to the I/O interface via processor interface 408. Memory 420 is connected to processor 402 via a memory interface 422. Memory 425 is connected to processor 404 via a memory interface 427. Graphics interface 430 is connected to I/O interface 410 via a graphics interface 432, and provides a video display output 435 to a video display 434. In a particular embodiment, information handling system 400 includes separate memories that are dedicated to each of processors 402 and 404 via separate memory interfaces. An example of memories 420 and 425 include random access memory (RAM) such as static RAM (SRAM), dynamic RAM (DRAM), non-volatile RAM (NV-RAM), or the like, read only memory (ROM), another type of memory, or a combination thereof.

BIOS/UEFI module 440, disk controller 450, and I/O bridge 470 are connected to I/O interface 410 via an I/O channel 412. An example of I/O channel 412 includes a Peripheral Component Interconnect (PCI) interface, a PCI-Extended (PCI-X) interface, a high-speed PCI-Express (PCIe) interface, another industry standard or proprietary communication interface, or a combination thereof. I/O interface 410 can also include one or more other I/O interfaces, including an Industry Standard Architecture (ISA) interface, a Small Computer Serial Interface (SCSI) interface, an Inter-Integrated Circuit (I2C) interface, a System Packet Interface (SPI), a Universal Serial Bus (USB), another interface, or a combination thereof. BIOS/UEFI module 440 includes BIOS/UEFI code operable to detect resources within information handling system 400, to provide drivers for the resources, initialize the resources, and access the resources. BIOS/UEFI module 440 includes code that operates to detect resources within information handling system 400, to provide drivers for the resources, to initialize the resources, and to access the resources.

Disk controller 450 includes a disk interface 452 that connects the disk controller to HDD 454, to ODD 456, and to disk emulator 460. An example of disk interface 452 includes an Integrated Drive Electronics (IDE) interface, an Advanced Technology Attachment (ATA) such as a parallel ATA (PATA) interface or a serial ATA (SATA) interface, a SCSI interface, a USB interface, a proprietary interface, or a combination thereof. Disk emulator 460 permits SSD 464 to be connected to information handling system 400 via an external interface 462. An example of external interface 462 includes a USB interface, an IEEE 1394 (Firewire) interface, a proprietary interface, or a combination thereof. Alternatively, solid-state drive 464 can be disposed within information handling system 400.

I/O bridge 470 includes a peripheral interface 472 that connects the I/O bridge to add-on resource 474, to TPM 476, and to network interface 480. Peripheral interface 472 can be the same type of interface as I/O channel 412, or can be a different type of interface. As such, I/O bridge 470 extends the capacity of I/O channel 412 when peripheral interface 472 and the I/O channel are of the same type, and the I/O bridge translates information from a format suitable to the I/O channel to a format suitable to the peripheral channel 472 when they are of a different type. Add-on resource 474 can include a data storage system, an additional graphics interface, a network interface card (NIC), a sound/video processing card, another add-on resource, or a combination thereof. Add-on resource 474 can be on a main circuit board, on a separate circuit board or add-in card disposed within information handling system 400, a device that is external to the information handling system, or a combination thereof.

Network interface 480 represents a NIC disposed within information handling system 400, on a main circuit board of the information handling system, integrated onto another component such as I/O interface 410, in another suitable location, or a combination thereof. Network interface device 480 includes network channels 482 and 484 that provide interfaces to devices that are external to information handling system 400. In a particular embodiment, network channels 482 and 484 are of a different type than peripheral channel 472 and network interface 480 translates information from a format suitable to the peripheral channel to a format suitable to external devices. An example of network channels 482 and 484 includes InfiniBand channels, Fibre Channel channels, Gigabit Ethernet channels, proprietary channel architectures, or a combination thereof. Network channels 482 and 484 can be connected to external network resources (not illustrated). The network resource can include another information handling system, a data storage system, another network, a grid management system, another suitable resource, or a combination thereof.

Management device 490 represents one or more processing devices, such as a dedicated baseboard management controller (BMC) System-on-a-Chip (SoC) device, one or more associated memory devices, one or more network interface devices, a complex programmable logic device (CPLD), and the like, that operate together to provide the management environment for information handling system 400. In particular, management device 490 is connected to various components of the host environment via various internal communication interfaces, such as a Low Pin Count (LPC) interface, an Inter-Integrated-Circuit (I2C) interface, a PCIe interface, or the like, to provide an out-of-band (00B) mechanism to retrieve information related to the operation of the host environment, to provide BIOS/UEFI or system firmware updates, to manage non-processing components of information handling system 400, such as system cooling fans and power supplies. Management device 490 can include a network connection to an external management system, and the management device can communicate with the management system to report status information for information handling system 400, to receive BIOS/UEFI or system firmware updates, or to perform other task for managing and controlling the operation of information handling system 400. Management device 490 can operate off of a separate power plane from the components of the host environment so that the management device receives power to manage information handling system 400 when the information handling system is otherwise shut down. An example of management device 490 includes a commercially available BMC product or other device that operates in accordance with an Intelligent Platform Management Initiative (IPMI) specification, a Web Services Management (WSMan) interface, a Redfish Application Programming Interface (API), another Distributed Management Task Force (DMTF), or other management standard, and can include an Integrated Dell Remote Access Controller (iDRAC), an Embedded Controller (EC), or the like. Management device 490 may further include associated memory devices, logic devices, security devices, or the like, as needed or desired.

Although only a few exemplary embodiments have been described in detail herein, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

The above-disclosed subject matter is to be considered illustrative, and not restrictive, and the appended claims are intended to cover any and all such modifications, enhancements, and other embodiments that fall within the scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. An information handling system; comprising:
a chassis;
a motherboard installed within the chassis;
a first backplane coupled to the motherboard and located in a front side of the chassis, wherein the first backplane is configured to receive first add-in modules from the front of the chassis; and
a second backplane coupled to the motherboard and located in a middle portion of the chassis, wherein the second backplane is configured to receive second add-in modules, wherein the second add-in modules are positioned above dual in-line memory modules (DIMMs) installed in the motherboard.

2. The information handling system of claim 1, further comprising a processor coupled to the first backplane, to the second backplane, and to the DIMMs.

3. The information handling system of claim 2, wherein the second backplane is coupled to a port of the processor that is located on a downstream side of the processor with respect to an airflow provided by a fan of the information handling system.

4. The information handling system of claim 3, wherein the port is a Peripheral Component Interconnect Express (PCIe) port.

5. The information handling system of claim 4, wherein the PCIe port is a compute express link (CXL) port.

6. The information handling system of claim 5, wherein the second backplane includes a CXL switch.

7. The information handling system of claim 1, wherein the first add-in modules and the second add-in modules are enterprise and data small form factor (EDSFF) devices.

8. The information handling system of claim 7, wherein the first add-in modules and the second add-in modules are EDSFF type E.1 form factor devices.

9. The information handling system of claim 8, wherein the first add-in modules and the second add-in modules are EDSFF type E.3 form factor devices.

10. The information handling system of claim 1, wherein the chassis is a 2U server chassis.

11. A method comprising:
coupling a first backplane of an information handling system to a motherboard of the information handling system, wherein the first backplane is located in a front side of a chassis and is configured to receive first add-in modules from the front of the chassis; and
coupling a second backplane of the information handling system to the motherboard, wherein the second backplane is located in a middle portion of the chassis and is configured to receive second add-in modules, wherein the second add-in modules are positioned above dual in-line memory modules (DIMMs) installed in the motherboard.

12. The method of claim 11, further comprising coupling a processor to the first backplane, to the second backplane, and to the DIMMs.

13. The method of claim 12, wherein the second backplane is coupled to a port of the processor that is located on a downstream side of the processor with respect to an airflow provided by a fan of the information handling system.

14. The method of claim 13, wherein the port is a Peripheral Component Interconnect Express (PCIe) port.

15. The method of claim 14, wherein the PCIe port is a compute express link (CXL) port.

16. The method of claim 15, wherein the second backplane includes a CXL switch.

17. The method of claim 11, wherein the first add-in modules and the second add-in modules are enterprise and data small form factor (EDSFF) devices.

18. The method of claim 17, wherein the first add-in modules and the second add-in modules are EDSFF type E.1 form factor devices.

19. The method of claim 18, wherein the first add-in modules and the second add-in modules are EDSFF type E.3 form factor devices.

20. An information handling system; comprising:
a motherboard installed within a chassis, the motherboard including a processor and dual in-line memory modules (DIMMs) coupled to the processor;
a first backplane coupled to the processor and located in a front side of the chassis, wherein the first backplane is configured to receive first add-in modules from the front of the chassis; and
a second backplane coupled to the processor and located in a middle portion of the chassis, wherein the second backplane is configured to receive second add-in modules, wherein the second add-in modules are positioned above the DIMMs.
